(19) United States
(12) Patent Application Publication
(10) Pub. No.: US 2005/0204347 A1
(43) Pub. Date: Sep. 15, 2005

(54) Method for generating XSLT documents from multiple versions of a UML model or XML schemas created from multiple versions of a UML model

(75) Inventors: Jared Pasha Jurkiewicz, Durham, NC (US); Christopher C. Mitchell, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/800,067

(22) Filed: Mar. 12, 2004

(51) Int. Cl. G06F 9/45

(52) U.S. Cl. 717/137

(57) ABSTRACT

A method, apparatus, and computer instructions are disclosed for generating XSLT documents from multiple versions of a UML model or XML schemas created from multiple versions of a UML model. The innovative tool can take a newer and older version of a UML model, or the XML schemas created from a newer and older version of a UML model, and run those documents through a difference tool that produces a report describing the changes made to the older version by the newer version. Then, an XSL template-match fragment can be created for each “feature added” change made to the older version. Each such XSL template-match fragment can be used to filter the corresponding configuration settings from an XML document in the newer schema's format. Also, for each “feature added” change made to the older version, an XSL template-match fragment can be created and used to add the configuration setting(s) and a default value to an older document. Consequently, a document having the older schema's format can be transformed into the new format (e.g., by adding new attribute values for the attributes that were added to the UML model).

### RELATED APPLICATIONS

The present application is related by subject matter to commonly assigned, co-pending U.S. patent application Ser. No. [______] (Attorney Docket No. RSW920030263US1) entitled “METHOD AND APPARATUS FOR MAINTAINING COMPATIBILITY WITHIN A DISTRIBUTED SYSTEMS MANAGEMENT ENVIRONMENT WITH A PLURALITY OF CONFIGURATION VERSIONS”, filed on Mar. 12, 2004, and hereby incorporated by reference.

### BACKGROUND OF THE INVENTION

1. Technical Field

The present invention relates generally to systems management in a dynamic electronic-business (e-business) network environment, and in particular, but not exclusively to, a method, apparatus and computer instructions for generating Extensible Style Language Transformation (XSLT) documents from multiple versions of a Unified Modeling Language (UML) model or Extensible Markup Language (XML) schemas created from multiple versions of a UML model.

2. Description of Related Art

The use of the Internet for business transactions has increased significantly in recent years. In fact, the term “e-business” has evolved to mean doing business on-line. WebSphere is a set of Java™-based tools developed by International Business Machines Corporation of Armonk, N.Y., which allows customers to create and manage relatively sophisticated e-business Web sites. The primary WebSphere tool is the WebSphere Application Server, which is a Java™-based, high-performance Web applications server that businesses can use to connect Web site customers with e-business applications.

In the WebSphere Application Server Version 5.x environment, for example, established configuration settings for the installed versions of the WebSphere products are stored in XML documents. Each XML configuration document conforms to a schema (e.g., data format) or Document Type Definition (DTD), which defines the structure and syntax of the XML document and the allowable configuration settings that can be defined within the document. The structure and settings of these XML documents are initially modeled in UML notation using a design tool (e.g., “Rational Rose”). Additional tools are used to convert the UML model into XML schema documents, which are used primarily to validate the structure of the XML configuration documents. The XML schema documents are shipped with the WebSphere product as an aid for those customers who desire to understand the format of the XML documents.

Newer versions of the WebSphere product will have new configuration settings that will be added to the UML model. Then, newer versions of the XML schemas will be created from the modified UML model and shipped to customers along with the corresponding, newer versions of the WebSphere product. These new configuration settings will require the customers to migrate the configuration settings from their older versions of the product to their newer versions (e.g., upward migration). In order for the customers to perform this upward migration, an XSL document can be used to transform a configuration document from an older format into the newer format (e.g., with appropriate default values added for the newer configuration settings, if deemed necessary).

Cells are logical groupings of one or more nodes in a WebSphere Application Server distributed network. A cell retains the master configuration files (e.g., XML files) for each server in each node in the cell. In the future, numerous new versions of the WebSphere product will likely be produced (e.g., Versions 5.2, 6.0, 6.1, 7.0, etc.). However, for obvious reasons, customers are unlikely to want to reconfigure all of their servers each time a new version is produced. Consequently, many versions of the configuration data for the WebSphere product will have to co-exist within the same cell, which will significantly complicate the administrative management of the customers' cells.

Therefore, it would be advantageous to have an improved method, apparatus and computer instructions for automatically generating XSLT documents from multiple versions of a UML model or XML schemas created from multiple versions of a UML model.

Additionally, WebSphere Version 6 allows the coexistence of 6.x nodes within the same management environment as 5.x nodes. In this environment, the WebSphere management agents require that some 6.x format configuration documents can have 6.x configuration settings filtered from them so that the documents can be read by the 5.x nodes (as is the 5.x nodes were being managed by a 5.x agent). Therefore, it would be advantageous to have an improved method, apparatus and computer instructions for automatically generating XSLT documents that also supports this “reverse transformation” (filtering transformation) process.

### SUMMARY OF THE INVENTION

The present invention provides a method, apparatus, and computer instructions for generating XSLT documents from multiple versions of a UML model or XML schemas created from multiple versions of a UML model. The innovative tool, in a preferred embodiment, can take a newer and older version of a UML model, or the XML schemas created from a newer and older version of a UML model, and run those documents through a difference tool that produces a report describing the changes made to the older version by the newer version. Then, an XSL template-match fragment can be created for each “feature added” change made to the older version. Each such XSL template-match fragment can be used to filter the corresponding configuration settings from an XML document in the newer schema's format. Also, for each “feature added” change made to the older version, an XSL template-match fragment can be created and used to add the configuration setting(s) and a default value to an older document. Consequently, a document having the older schema's format can be transformed into the new format (e.g., by adding new attribute values for the attributes that were added to the UML model).

The use of XSLT transformations, in accordance with a preferred embodiment of the present invention, is important because the generated transformation document can be manually augmented by a developer to perform more complex filtering functions using XSLT's built in capabilities or calls to developer-provided scripts. This technique is often necessary when new attribute values are derived from properties in the previous configuration documents.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a data processing system in which the present invention may be implemented, in accordance with a preferred embodiment of the present invention;

FIG. 2 is a flowchart for a process for generating XSLT documents from multiple versions of a UML model or XML schemas created from multiple versions of a UML model, in accordance with a preferred embodiment of the present invention; and

FIG. 3 is an example of an output report from a model differencing tool used for a portion of a configuration mode, in accordance with a preferred embodiment of the present invention.

### DETAILED DESCRIPTION OF THE PREFERRED EMBODIMENT

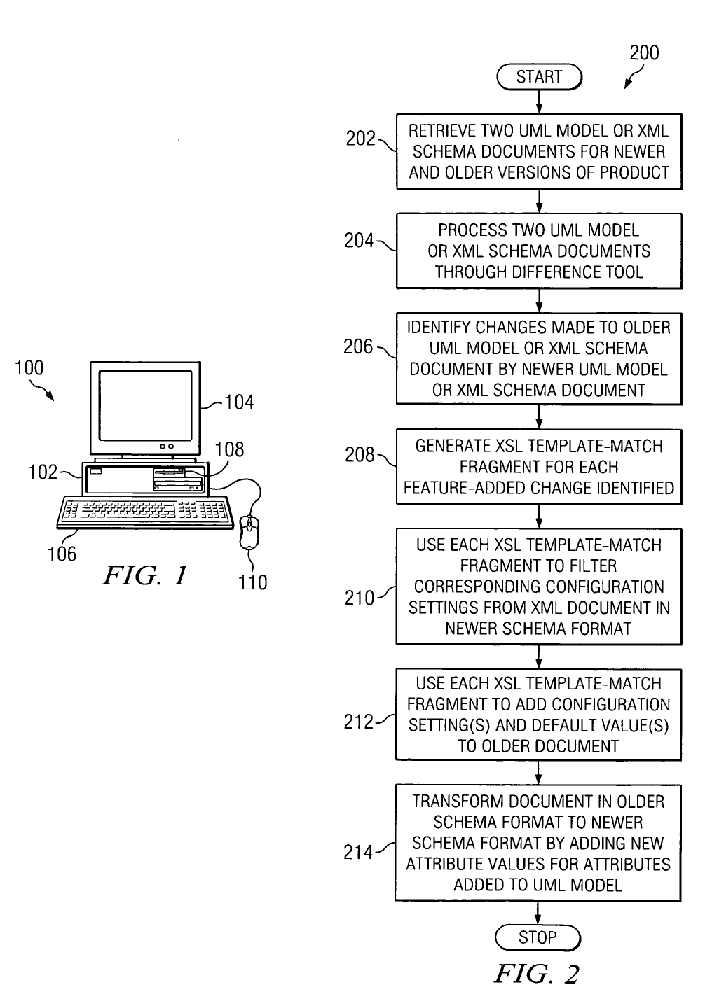

With reference now to the figures and in particular with reference to FIG. 1, a pictorial representation of a data processing system in which the present invention may be implemented, is depicted in accordance with a preferred embodiment of the present invention. For this example, data processing system 100 is depicted as a computer, computer workstation, personal computer, client computer, etc. However, the present invention is not intended to be so limited and can implemented by any suitable data processing unit that can perform the software-based functions of generating XSLT documents from multiple versions of a UML model or XML schemas created from multiple versions of a UML model, in accordance with the present invention (e.g., software modeling tool, differencing tool, filtering tool, etc.). For example, the tool functions of the present invention can also be implemented by software running in a server.

Computer 100 includes computer processing unit 102, video display terminal 104, keyboard 106, mouse 110, and storage devices 108, which may include one or more floppy drives, a CD-ROM drive, a hard disk drive, and other types of permanent and removable storage media. Additional input devices may be included with computer 100, such as, for example, a joystick, touch pad, touch screen, trackball, microphone, and the like.

Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer, and the like.

An Operating System (OS) runs on computer processing unit 102 and is used to coordinate and provide control of various components within computer 100. The OS may be commercially available, such as Windows 2000, which is available from Microsoft Corporation. An object-oriented programming system such as Java may run in conjunction with the OS and provide calls to the OS from Java programs or applications executing on computer processing unit 102. “Java” is a trademark of Sun Microsystems, Inc. Instructions for the OS, the object-oriented programming system, and applications or programs are located on storage devices, such as hard disk drive 108, and may be loaded into a main memory for execution by computer processing unit 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

With reference now to FIG. 2, a flowchart for a process for generating XSLT documents from multiple versions of a UML model or XML schemas created from multiple versions of a UML model, is depicted in accordance with a preferred embodiment of the present invention. The exemplary process illustrated in FIG. 2 may be implemented in a computer, such as, for example, computer 100 shown in FIG. 1. In any event, the exemplary process illustrated in FIG. 2 can be implemented in any suitable data processing system capable of providing software-based tools for processing UML model documents, XML schema documents generated from UML model documents, and XSLT documents created from UML model documents or XML schema documents in, for example, a WebSphere Application Server environment or similar environment.

Process 200 begins by retrieving two UML model documents or the XML schema documents generated from two UML model documents (step 202). For this exemplary embodiment, it may be assumed that the two UML model documents or XML schema documents generated from the two UML model documents are for a newer and older version of a WebSphere Applications Server product. Next, the two UML model documents or XML schema documents generated from the two UML model documents are input to a model difference tool (step 204), in order to produce an XML document containing differences between the two schemas. For example, an appropriate software design application (e.g., appropriate Rational Modeling tool with model differencing capabilities, Java Application Program Interface or API, etc.) can be used as a difference tool to compare the configuration documents for the newer and older versions of the WebSphere product.

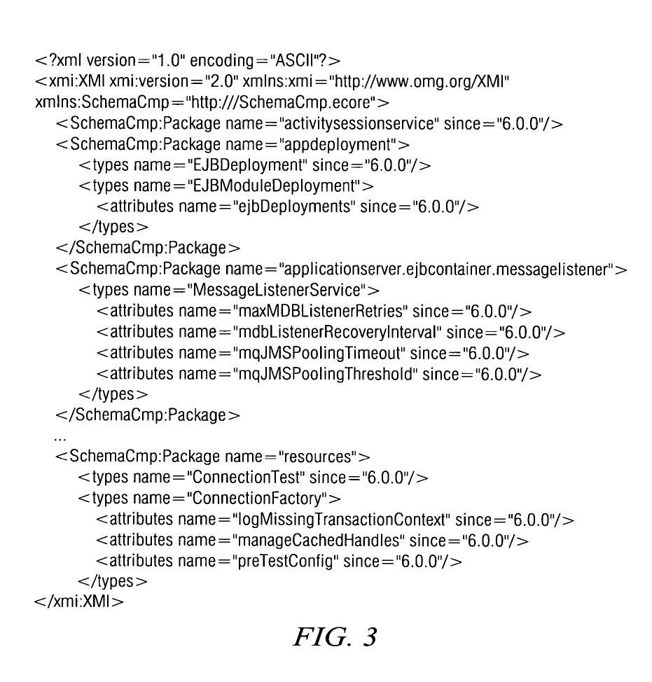

Next, for this example, the difference tool can provide a report that identifies all pertinent changes made to the older version UML model document or XML schema document(s) generated from that UML document, by the newer version UML model document or XML schema document(s) generated from that UML model document (step 206). For example, the pertinent changes identified can include any changed or new configuration setting(s) for a cell in a WebSphere Application Server environment, one or more nodes in a cell, each server defined in one or more nodes in a cell, or each application deployed in a cell. The changed configuration setting(s) can include any new attributes added in the newer configuration document. Such configuration attributes can include, for example, cell name, cell discovery protocol, cell discovery address endpoint name, cell type, foreign cells, properties (e.g., custom properties that apply across a cell), etc. For illustrative purposes and ease of understanding, and in accordance with the present invention, an example output from a model differencing tool used by WebSphere for a portion of the configuration mode is shown in FIG. 3.

Next, using the identified changes made to the configuration setting(s) in the older version UML document or XML schema document(s) generated from that UML document, an XSL template-match fragment can be generated for each “feature-added” change so identified (step 208). For this exemplary embodiment, an XSL template-match fragment (e.g., XSL document fragment forming a template including the “feature-added” changes). Each such generated XSL template-match fragment can then be used to filter out the corresponding configuration setting(s) (e.g., attributes) from a newer version XML schema document (step 210). Also, each such XSL template-match fragment can be used to add configuration setting(s) and default value(s) to the older version XML schema document (step 212). As such, for example, the generated XSL transform documents can be manually augmented with additional templates or more complex developer-provided functions.

Next, using the XSL fragments to filter out the non-changed configuration setting(s) from the newer version XML schema document (at step 210), and add in the changed configuration setting(s) and default value(s) to the older version XML schema document (at step 212), an XSL processor can be used to transform the older version XML schema document to the newer version schema format (step 214). As such, in accordance with the present invention, process 200 has generated XSLT documents (e.g., using XSL template-match fragments) from two versions (e.g., older and newer versions) of a UML model or XML schemas created from the two versions of the UML model. The XSLT documents (e.g., instructions provided in XSLT style sheets) can be read by an XSL processor and used to transform XML schema documents in the older schema format to XML schema documents having the newer schema format.

It is important to note that while the present invention has been described in the context of a fully functioning data processing system or computer, those of ordinary skill in the art will appreciate that the processes of the present invention are capable of being distributed in the form of a computer-readable medium of instructions and a variety of forms and that the present invention applies equally regardless of the particular type of signal bearing media actually used to carry out the distribution. Examples of computer-readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer-readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for creating an Extensible-Style Language Transformation (XSLT) document from a plurality of Unified Modeling Language (UML) model documents or Extensible Markup Language (XML) schemas created from the plurality of UML model documents, the method comprising the steps of:
providing a plurality of UML documents;
determining at least one difference between a content of one UML document of said plurality of UML documents and a content of a second UML document of said plurality of UML documents; and
creating an XSL fragment including said at least one difference between said content of said one UML document of said plurality of UML documents and said content of said second UML document of said plurality of UML documents.

2. The method of claim 1, wherein the providing, determining and creating steps comprise the steps of:
providing a plurality of XML schema documents from said plurality of UML documents;
determining at least one difference between a content of one XML schema document of said plurality of XML schema documents and a content of a second XML schema document of said plurality of XML schema documents; and
creating an XSL fragment including said at least one difference between said content of said one XML schema document of said plurality of XML schema documents and said content of said second XML schema document of said plurality of XML schema documents.

3. The method of claim 1, further comprising the steps of:
filtering out at least one non-difference from said content of said one UML document of said plurality of UML documents; and
adding said at least one difference to said content of said second UML document of said plurality of UML documents.

4. The method of claim 2, wherein the filtering and adding steps comprise the steps of:
filtering out at least one non-difference from said content of said one XML schema document of said plurality of XML schema documents; and
adding said at least one difference to said content of said second XML schema document of said plurality of XML schema documents.

5. The method of claim 1, further comprising the step of transforming a format of said one UML document to a format of said second UML document.

6. The method of claim 1, wherein said plurality of UML documents comprises two UML documents.

7. The method of claim 1, wherein said content of said one UML document comprises configuration settings for an older version of a product, and said content of said second UML document comprises configuration settings for a newer version of said product.

8. The method of claim 1, wherein said content of said one UML document comprises a plurality of attributes for an older version of a product, and said content of said second UML document comprises a plurality of attributes for a newer version of said product.

9. An apparatus for creating an Extensible-Style Language Transformation (XSLT) document from a plurality of Unified Modeling Language (UML) model documents or Extensible Markup Language (XML) schemas created from the plurality of UML model documents, comprising:
a storage unit, said storage unit operable to:
provide a plurality of UML documents; and a processor unit, said processor unit coupled to said storage unit and operable to:
determine at least one difference between a content of one UML document of said plurality of UML documents and a content of a second UML document of said plurality of UML documents; and
create an XSL fragment including said at least one difference between said content of said one UML document of said plurality of UML documents and said content of said second UML document of said plurality of UML documents.

10. The apparatus of claim 9, wherein the providing, determining and creating operations comprise operations to:
provide a plurality of XML schema documents from said plurality of UML documents;
determine at least one difference between a content of one XML schema document of said plurality of XML schema documents and a content of a second XML schema document of said plurality of XML schema documents; and
create an XSL fragment including said at least one difference between said content of said one XML schema document of said plurality of XML schema documents and said content of said second XML schema document of said plurality of XML schema documents.

11. The apparatus of claim 9, wherein said processor unit is further operable to:
filter out at least one non-difference from said content of said one UML document of said plurality of UML documents; and
add said at least one difference to said content of said second UML document of said plurality of UML documents.

12. The apparatus of claim 10, wherein the filtering and adding operations comprise operations to:
filter out at least one non-difference from said content of said one XML schema document of said plurality of XML schema documents; and
add said at least one difference to said content of said second XML schema document of said plurality of XML schema documents.

13. The apparatus of claim 9, wherein said processor unit is further operable to transform a format of said one UML document to a format of said second UML document.

14. The apparatus of claim 9, wherein said plurality of UML documents comprises two UML documents.

15. The apparatus of claim 9, wherein said content of said one UML document comprises configuration settings for an older version of a product, and said content of said second UML document comprises configuration settings for a newer version of said product.

16. The apparatus of claim 9, wherein said content of said one UML document comprises a plurality of attributes for an older version of a product, and said content of said second UML document comprises a plurality of attributes for a newer version of said product.

17. A computer program product in a computer readable medium for creating an Extensible-Style Language Transformation (XSLT) document from a plurality of Unified Modeling Language (UML) model documents or Extensible Markup Language (XML) schemas created from the plurality of UML model documents, the computer program product comprising:
first instructions for providing a plurality of UML documents;
second instructions for determining at least one difference between a content of one UML document of said plurality of UML documents and a content of a second UML document of said plurality of UML documents; and
third instructions for creating an XSL fragment including said at least one difference between said content of said one UML document of said plurality of UML documents and said content of said second UML document of said plurality of UML documents.

18. The computer program product of claim 17, wherein the first, second and third instructions comprise:
first instructions for providing a plurality of XML schema documents from said plurality of UML documents;
second instructions for determining at least one difference between a content of one XML schema document of said plurality of XML schema documents and a content of a second XML schema document of said plurality of XML schema documents; and
third instructions for creating an XSL fragment including said at least one difference between said content of said one XML schema document of said plurality of XML schema documents and said content of said second XML schema document of said plurality of XML schema documents.

19. The computer program product of claim 17, further comprising:
fourth instructions for filtering out at least one non-difference from said content of said one UML document of said plurality of UML documents; and
fifth instructions for adding said at least one difference to said content of said second UML document of said plurality of UML documents.

20. The computer program product of claim 18, wherein the fourth and fifth instructions comprise:
fourth instructions for filtering out at least one non-difference from said content of said one XML schema document of said plurality of XML schema documents; and
fifth instructions for adding said at least one difference to said content of said second XML schema document of said plurality of XML schema documents.
